(19) United States
(12) Patent Application Publication
(10) Pub. No.: US 2009/0167757 A1
(43) Pub. Date: Jul. 2, 2009

(54) APPARATUS AND METHOD FOR CONVERTING COLOR OF 3-DIMENSIONAL IMAGE

(76) Inventors: Hye On JANG, Seongnam-si (KR); Jae Young LIM, Yongin-si (KR)

Correspondence Address: MCNEELY BODENDORF LLP, P.O. BOX 34175, WASHINGTON, DC, 20043, US

(21) Appl. No.: 12/042,852

(22) Filed: Mar. 5, 2008

(30) Foreign Application Priority Data
Dec. 30, 2007 (KR) 10-2007-0124581

(51) Int. Cl. G06T 15/00

(52) U.S. Cl. 345/419

(57) ABSTRACT

An apparatus and method of processing a three dimensional (3D) image are provided. An apparatus for processing a 3D image includes an image receiver to receive the 3D image and external illumination information associated with the 3D image, a saturation converter to convert a saturation of the 3D image based on the external illumination information, and an illumination converter to convert an illumination of the 3D image based on the external illumination information.

### CROSS-REFERENCE TO RELATED APPLICATION

This application claims the benefit under 35 U.S.C. § 119(a) of a Korean Patent Application No. 10-2007-0124581, filed on Dec. 3, 2007, in the Korean Intellectual Property Office, the entire disclosure of which is incorporated herein by reference.

### TECHNICAL FIELD

The following description relates to an apparatus and method of processing a three dimensional (3D) image, and more particularly, to an apparatus and method of converting a color of a 3D image based on an external illumination of an image display device displaying the 3D image.

### BACKGROUND

Due to the developments in computer technologies, media using computer graphics are increasing. In the media using computer graphics, a three dimensional (3D) game or a computer animation constitutes a thing, a character, a building, and the like, which is represented in an image, using a 3D object. Generally, a screen processing apparatus of the 3D game or a 3D engine of embodying the computer animation determines a color of the 3D object based on a color and a light source of the 3D object.

A user may view the 3D image displayed on the image display device. If the image display device is under a relatively bright light, the user may not clearly view the image displayed on the image display device.

In order to more clearly view the 3D image displayed on the image display device under the bright light, a conventional method uses a scheme of measuring peripheral illumination information of the image display device and increasing a 3D image output illumination of the image display device. However, there is constraint on increasing an illumination of, for example, a liquid crystal display (LCD) that constitutes the image display device. Therefore, increasing the illumination of the image display device may not be a suitable solution.

Also, when increasing the illumination of the image display device to greater than a predetermined level, a phenomenon of being incapable of viewing the 3D image may occur.

Accordingly, there is a need for a technology that converts a color of a 3D image based on peripheral illumination information of an image display device to enable a user to more clearly view the 3D image where the image display device is under a bright light.

### SUMMARY

In one general aspect, there is provided an apparatus and method that converts a color of a three dimensional (3D) image based on external illumination information associated with the 3D image. Accordingly, the 3D image may be more clearly visible even where an image display device displaying the 3D image is under a bright light.

According to another aspect, there is provided an apparatus for processing a 3D image, the apparatus including an image receiver to receive the 3D image and external illumination information associated with the 3D image, a saturation converter to convert a saturation of the 3D image based on the external illumination information, and an illumination converter to convert an illumination of the 3D image based on the external illumination information.

According to still another aspect, there is provided a method of processing a 3D image, the method including receiving the 3D image and external illumination information associated with the 3D image, converting a saturation of the 3D image based on the external illumination information, and converting an illumination of the 3D image based on the external illumination information.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating an exemplary three dimensional (3D) image processing apparatus.

FIG. 2 is a block diagram illustrating a structure of the 3D image processing apparatus of FIG. 1.

FIG. 3 is a block diagram illustrating a structure of a saturation converter of FIG. 2.

FIG. 4 is a block diagram illustrating a structure of an illumination converter of FIG. 2.

FIG. 5 illustrates a lookup table associated with an illumination value of each of zones constituting a 3D image according to an exemplary embodiment.

FIG. 6 is a flowchart illustrating a method of processing a 3D image according to an exemplary embodiment. FIG. 7 is a flowchart illustrating a method of converting a saturation of a 3D image according to an exemplary embodiment.

FIG. 8 is a flowchart illustrating a method of converting an illumination of a 3D image according to an exemplary embodiment.

Throughout the drawings and the detailed description, the same drawing reference numerals will be understood to refer to the same elements, features, and structures.

### DETAILED DESCRIPTION

The following detailed description is provided to assist the reader in gaining a comprehensive understanding of the methods and systems described herein. Accordingly, various changes, modifications, and equivalents of the systems and methods described herein will be suggested to those of ordinary skill in the art. Also, descriptions of well-known functions and constructions are omitted to increase clarity and conciseness.

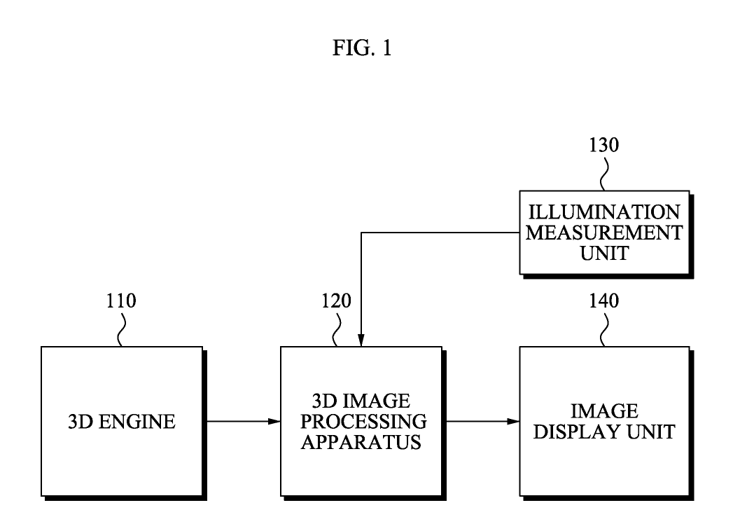

FIG. 1 illustrates an exemplary three dimensional (3D) image processing apparatus 120. The three dimensional (3D) image processing apparatus 120 converts a color of a 3D image based on external illumination information associated with the 3D image to make the 3D image more clearly visible. Hereinafter, the concept of converting the color of the 3D image by the 3D image processing apparatus 120 will be described in detail with reference to FIG. 1.

A 3D engine 110 creates a 3D image from image data and the like. According to an aspect, the 3D image created by the 3D engine 110 may be a still image or a moving picture. In the case of the moving picture, a plurality of still images is consecutively displayed on an image display device. Therefore, when converting the color of the 3D image with respect to the still images and consecutively displaying the still images, the embodiments and teachings disclosed herein may be applicable to the moving picture.

The 3D engine 110 may be interpreted as a concept that includes all 3D image creating apparatuses for displaying a 3D object on a screen in a game, an animation, a movie, and the like.

The 3D image processing apparatus 120 converts the color of the 3D image based on external illumination information associated with the 3D image that is created by the 3D engine 110. When an image display device for displaying the 3D image is in the open air, a user may not clearly view the 3D image due to the outside bright light. However, according to an aspect, the 3D image processing apparatus 120 may convert the color of the 3D image based on the external illumination information associated with the 3D image and thereby enable the user to clearly view the 3D image even under the bright light.

An illumination measurement unit 130 measures a peripheral illumination of the image display device of displaying the 3D image and creates external illumination information associated with the 3D image based on the measured illumination.

An image display device 140 displays the 3D image of which color is converted by the 3D image processing apparatus 120 based on the external illumination information. Since the color of the 3D image is converted based on the external illumination information, the user may clearly view the 3D image even when the image display device 140 is in the open air or under the bright light.

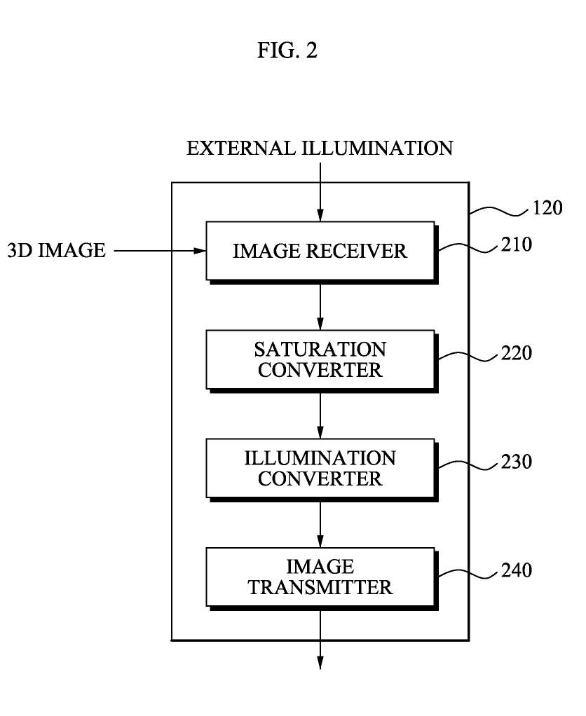

FIG. 2 illustrates a structure of the 3D image processing apparatus 120 of FIG. 1. Hereinafter, the structure of the 3D image processing apparatus 120 will be described in detail with reference to FIG. 2. The 3D image processing apparatus 120 according to an exemplary embodiment includes an image receiver 210, a saturation converter 220, an illumination converter 230, and an image transmitter 240.

The image receiver 210 receives a 3D image from the 3D engine 110 and receives external illumination information associated with the 3D image from the illumination measurement unit 130. According to an aspect, the external illumination information associated with the 3D image is peripheral illumination information of the image display device 140 displaying the 3D image. Therefore, the external illumination information may denote information about the illumination of a light in a location of the image display device 140. The received 3D image is created without considering illumination information. Therefore, when the image display device 140 is under the bright light, a user may not clearly view the 3D image displayed on the image display device 140.

According to an aspect, the image receiver 210 may receive the 3D image in a red-green-blue (RGB) form and may include a pre-processing unit (not shown) to convert the received 3D image from the RGB form to a YCbCr form. The 3D engine 110 may create the 3D engine in the RGB form. When the 3D image processing apparatus 120 directly converts the color of the 3D image in the RGB form, a great amount of calculations may be needed for the conversion. Therefore, the 3D image processing apparatus 120 may not be embodied in an environment with a limited calculation ability such as a mobile communication terminal, a personal digital assistant (PDA), and the like. However, when the 3D image processing apparatus 120 converts the 3D image from the RGB form to the YCbCr form and then converts a color of the 3D image in the YCbCr form, a small amount of calculations may be needed for the conversion. Therefore, the 3D image processing apparatus 120 may be readily embodied even in the environment with the limited calculation ability.

According to an aspect, when the received 3D image is compressed, the pre-processing unit may decompress the compressed 3D image and enable the saturation converter 220 and the illumination converter 230 to readily process the 3D image.

The saturation converter 220 converts a saturation of the 3D image based on peripheral illumination information of the image display device 140, that is, based on the external illumination information.

The illumination converter 230 converts an illumination of the 3D image based on the peripheral illumination information of the image display device 140, that is, based on the external illumination information.

The 3D image processing apparatus 120 converts the saturation and the illumination based on illumination information associated with the 3D image. Therefore, even when the image display device 140 is under the bright light, the user may clearly view the 3D image of which the saturation and the illumination are converted.

The image transmitter 240 transmits to the image display device 140 the 3D image of which the saturation and the illumination are converted by the saturation converter 220 and the illumination converter 230, respectively. The 3D image processing apparatus 120 processes the 3D image received from the 3D engine 110, and transmits the processed 3D image to the image display device 140. The 3D image processing apparatus may use the general 3D engine 110 and the image display device 140 as is, or may be implemented separately from the general 3D engine 110 and the image display device 140.

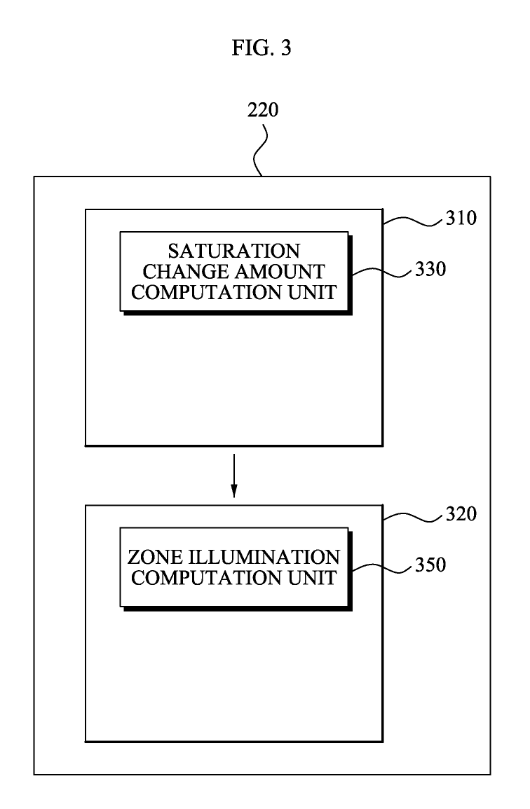

FIG. 3 illustrates a structure of the saturation converter 220 of FIG. 2. Hereinafter, the structure of the saturation converter 220 of the 3D image processing apparatus 120 will be described in detail with reference to FIG. 3. The saturation converter 220 includes an entire saturation converter 310 and a zone saturation converter 320.

The entire saturation converter 310 computes a saturation change amount of the 3D image based on the illumination of the 3D image and converts the entire saturation of the 3D image by the saturation change amount. According to an aspect, the entire saturation converter 310 may include a saturation change amount computation unit 330 to compute the saturation change amount of the 3D image.

The saturation change amount computation unit 330 computes the saturation change amount of the 3D image based on the illumination of the 3D image. According to an aspect, when there is a great difference between external illumination information associated with the 3D image and the illumination of the 3D image, the saturation change amount computation unit 330 may compute the saturation change amount as a large value. Conversely, when there is a small difference, the saturation change amount computation unit 330 may compute the saturation change amount as a small value.

The entire saturation converter 310 converts the entire saturation of the 3D image by the computed saturation change amount. According to an aspect, when the computed saturation change amount is greater than 0, the entire saturation of the 3D image may be increased. When the saturation of the 3D image is increased, each color of the 3D image may be clearer and thus the user may more clearly view the 3D image under the bright light.

According to an aspect, when the image display device 140 of displaying the 3D image is in the open air, external illumination information associated with the 3D image may have a large value. In this case, the saturation change amount computation unit 330 computes a large value of saturation change amount and the entire saturation converter 310 changes the saturation of the 3D image by the computed saturation change amount. The saturation of the 3D image is converted based on the external illumination information associated with the 3D image and thus the user may clearly view the 3D image.

The zone saturation converter 320 divides the 3D image into a plurality of zones and converts a saturation of each zone based on an illumination value of each zone. According to an aspect, the zone saturation converter 320 may include a zone illumination computation unit 350 to divide the 3D image into the plurality of zones and compute an illumination value of each zone.

The zone saturation converter 320 converts the saturation of each zone based on the illumination value of each zone computed by the zone illumination computation unit 350. The computed saturation change amount does not reflect the illumination of each of zones constituting the 3D image. Therefore, when collectively converting the saturation of each of zones constituting the 3D image, the feature of each zone may be insufficiently reflected. Therefore, the user may feel uncomfortable with viewing the 3D image. The zone saturation converter 320 may reconvert a saturation value of each zone based on the computed illumination value of each zone and thereby make 3D image naturally visible under the bright light.

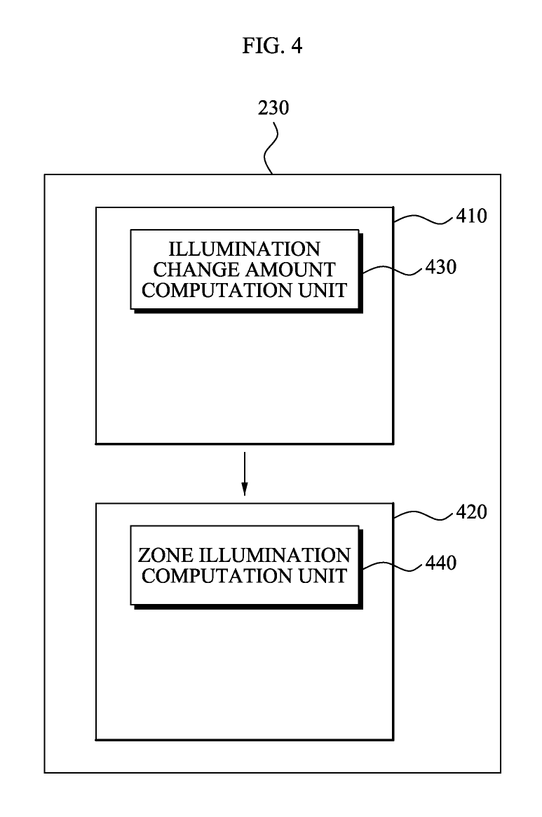

FIG. 4 illustrates a structure of the illumination converter 230 of FIG. 2. Hereinafter, the structure of the illumination converter 230 will be described in detail with reference to FIG. 4. The illumination converter 230 includes an entire illumination converter 410 and a zone illumination converter 420.

Analogous to the saturation converter 220 described with reference to FIG. 3, the illumination converter 230 of FIG. 4 converts the entire illumination of the 3D image based on the illumination of the 3D image, and reconverts an illumination of each of zones constituting the 3D image, based on the illumination of each zone.

According to an aspect, the entire illumination converter 410 may include an illumination change amount computation unit 430 to compute an illumination change amount of the 3D image based on external illumination information associated with the 3D image and the illumination of the 3D image. The entire illumination converter 410 converts the illumination of the 3D image by the computed illumination change amount.

According to an aspect, the zone illumination converter 420 may divide the 3D image into a plurality of zones and convert an illumination of each zone based on an illumination value of each zone. Also, the zone illumination converter 420 may include a zone illumination computation unit 440 to compute the illumination value of each zone, and may convert the illumination of each zone based on the computed illumination value.

The illumination change amount computed by the illumination change amount computation unit 430 is based on only the average illumination of the 3D image, instead of the illumination of each of zones constituting the 3D image. Therefore, when collectively converting the illumination of each of the zones constituting the 3D image according to the computed illumination change amount, the feature of each zone may be insufficiently reflected. Therefore, the user may feel uncomfortable when viewing the 3D image. The zone illumination converter 430 may reconvert an illumination value of each zone based on the computed illumination value of each zone and thereby make the 3D image naturally visible under the bright light.

According to an aspect, the illumination converter 230 may include a memory (not shown) that stores a lookup table. The lookup table includes a combination of an illumination value of each of zones constituting the 3D image and at least one converted illumination value corresponding to the illumination value. The zone illumination converter 420 may select a converted illumination value of the zone from the at least one converted illumination value based on the external illumination information by referring to the lookup table.

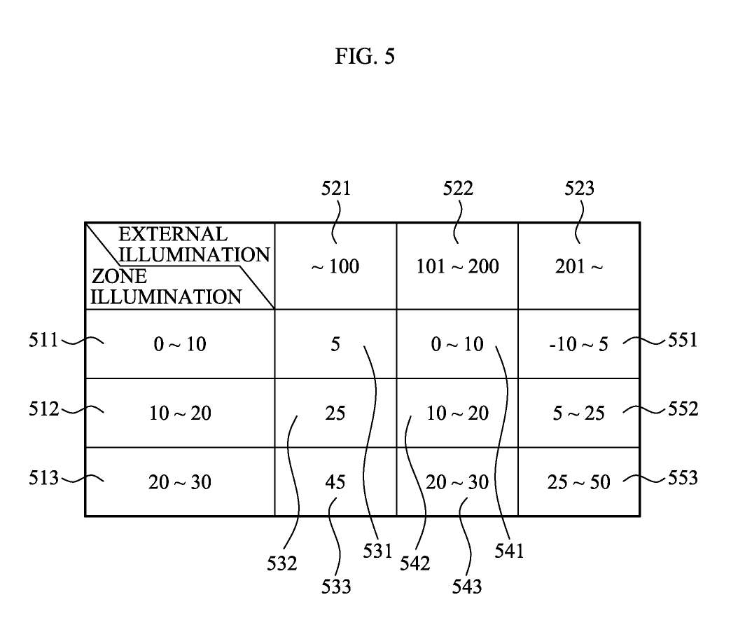

FIG. 5 illustrates a lookup table associated with an illumination value of each of zones constituting a 3D image according to an exemplary embodiment. Hereinafter, the configuration of the lookup table and converting of the illumination of each zone using the lookup table will be described in detail with reference to FIG. 5. The lookup table is used to convert the illumination value of each of zones constituting the 3D image. The lookup table includes combinations of zone illuminations 511, 512, and 513 of zones constituting the 3D image and external illumination information 521, 522, and 523.

An illumination value of each zone and an external illumination information value are used to describe the exemplary embodiments. Therefore, the values may be unassociated with a substantial illumination value of each of zones constituting a real 3D image and an external illumination information value.

According to an aspect, when an illumination value of each of zones constituting the 3D image is within the range of 0 through 10 corresponding to the zone illumination 511, a converted illumination value is determined as ‘5’ in a cell 531 that is within the range of the original illumination value of each zone. However, when the illumination value of each zone is in the range of 10 through 20 corresponding to the zone illumination 512, the converted illumination value may be determined as ‘25’ in a cell 532. Also, when the illumination value of each zone is within the range of 20 through 30 corresponding to the zone illumination 513, the converted illumination value may be determined as ‘45’ in a cell 533. Specifically, the converted illumination value may deviate from the original range.

According to another aspect, when an external illumination information value associated with the 3D image is within the predetermined range corresponding to the external illumination information 522, the illumination of each of zones constituting the 3D image may not be converted in cells 541, 542, and 543.

According to still another aspect, when the external illumination information value of each zone is 201 or more corresponding to the external illumination information 523, the illumination value of the zone illumination 511 may be converted to −10 through 5 in a cell 551. The illumination value of the zone illumination 512 may be converted to 5 through 25 in a cell 552. Also, the illumination value of the zone illumination 513 may be converted to 25 through 50 in a cell 553.

According to an aspect, an original illumination value of each zone may be linearly or nonlinearly converted to a converted illumination value.

Also, according to an aspect, the saturation converter 220 may include a memory (not shown) storing a lookup table. The lookup table includes a combination of the saturation of each of zones constituting the 3D image and at least one converted saturation value corresponding to the saturation. The saturation converter 220 may select a converted saturation value of the zone from the at least one converted saturation value by referring to the lookup table. Also, the saturation converter 220 may convert the saturation of each zone according to the selected converted saturation value.

The saturation converter 220 converting the saturation of each of zones constituting the 3D image by referring to the lookup table is similar to the illumination converter 230 converting the illumination of each of zones constituting the 3D image by referring to the lookup table. Thus, further detailed descriptions related thereto will be omitted.

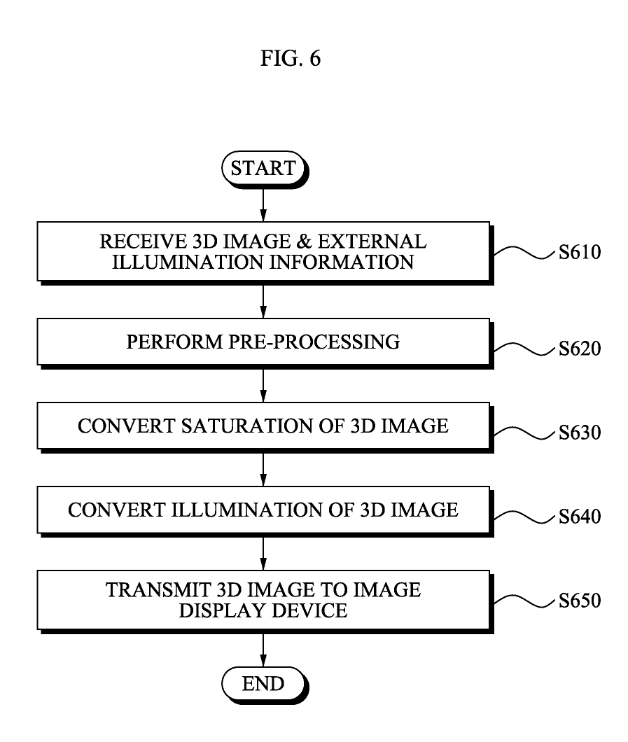

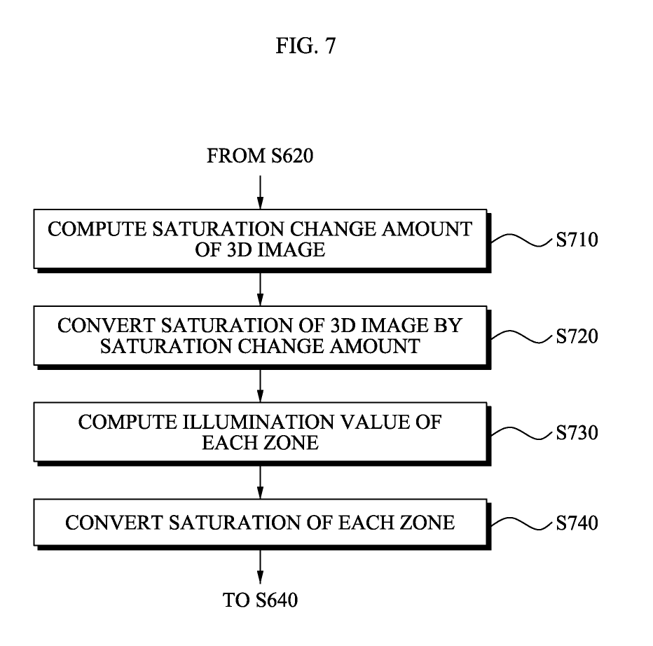

FIG. 6 illustrates a method of processing a 3D image according to an exemplary embodiment. Hereinafter, the 3D image processing method will be described in detail with reference to FIG. 6.

In operation S610, the 3D image and external illumination information associated with the 3D image are received. According to an aspect, in operation S610, a 3D image created by a 3D engine may be received. The 3D image created by the 3D engine is created without considering peripheral illumination information of an image display device of displaying the 3D image. Therefore, when the image display device is in the open air or under the bright light, a user may not clearly view the 3D image under the bright light.

According to an aspect, external illumination information associated with the 3D image may denote peripheral illumination information of the image display device of displaying the 3D image. When the image display device is in the open air or under the bright light, the external illumination information associated with the 3D image may have a large value.

In operation S620, pre-processing associated with the 3D image may be performed.

According to an aspect, when the 3D image in an RGB form is received in operation S610, the 3D image may be converted from the RGB form to a YCbCr form in operation S620 to readily convert the saturation and the illumination of the 3D image.

According to another aspect, when the received 3D image is compressed in operation S610, the compressed 3D image may be decompressed in operation S620, to readily convert the color of the 3D image in each subsequent operation.

In operation S630, an illumination of the 3D image is converted based on the external illumination information. In the case of the 3D image of which the saturation is converted, color contrast becomes very distinct under the bright light. Therefore, even when the image display device is under the bright light, the user may clearly view the 3D image.

In operation S640, an illumination of the 3D image is converted based on a value of the received external illumination information. A brighter portion of the 3D image may be emphasized to be brighter and conversely, a darker portion of the 3D image may be emphasized to be darker, based on the external illumination information. Therefore, the user may clearly view the 3D image under the bright light.

In operation S650, it may be possible to transmit to the image display device the 3D image of which the saturation and the illumination are respectively converted in operations S630 and S640.

FIG. 7 illustrates a method of converting a saturation of a 3D image according to an exemplary embodiment. Hereinafter, the method of converting the saturation of the 3D image will be described in detail with reference to FIG. 7.

In operation S710, a saturation change amount of the 3D image is computed based on the illumination of the 3D image. According to an aspect, when there is a great difference between external illumination information associated with the 3D image and the illumination of the 3D image, the computed saturation change amount may have a large value. Conversely, when there is a small difference, the computed saturation change amount may have a small value.

In operation S720, the entire saturation of the 3D image is converted by the computed saturation change amount. Since the entire saturation of the 3D image is converted by the computed saturation change amount, each color constituting the 3D image may become more distinct under the bright light. Therefore, even when the image display device of displaying the 3D image is under the bright light, the user may clearly view the 3D image.

In operation S730, the 3D image is divided into a plurality of zones and an illumination value of each zone is computed.

In operation S740, a saturation of each zone is converted based on the computed illumination value of each zone. In operation S720, the saturation conversion is performed with respect to the entire 3D image by the same amount of change. Therefore, a feature of each zone of the 3D image is not reflected. In operation S740, the saturation of each zone is converted based on the illumination value of each zone of the 3D image. Therefore, the feature of each zone of the 3D image is reflected and thus the user may clearly view the 3D image under the bright light.

According to an aspect, operation S740 may further include maintaining a lookup table that includes a combination of a saturation of each of zones constituting the 3D image and at least one converted saturation value corresponding to the saturation.

In operation S740, a converted saturation value of the zone may be selected from the at least one converted saturation value by referring to the lookup table. Also, in operation S740, the saturation of each zone may be converted according to the selected converted saturation value.

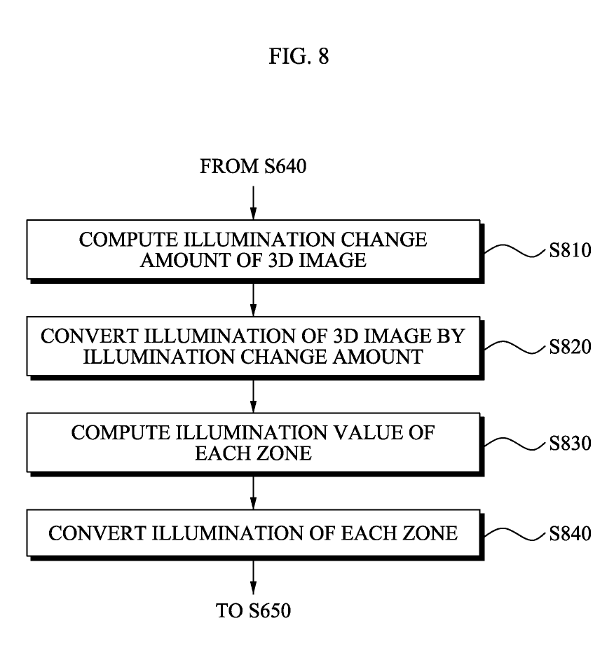

FIG. 8 illustrates a method of converting an illumination of a 3D image according to an exemplary embodiment. Hereinafter, the method of converting the illumination of the 3D image will be described in detail with reference to FIG. 8.

In operation S810, an illumination change amount of the 3D image is computed based on the illumination of the 3D image. According to an aspect, when the external illumination information associated with the 3D image has a large value, the illumination change amount of the 3D image may be determined as a large value. Conversely, when the external illumination information has a small value, the illumination change amount may be determined as a small value. When the external illumination information has a value less than a predetermined threshold, the illumination change amount may be set to ‘0’.

In operation S820, the entire illumination of the 3D image is converted by the computed illumination change amount. The entire illumination of the 3D image is converted. Therefore, even when the image display device of displaying the 3D image is under the bright light, the user may clearly view the 3D image.

In operation S830, the 3D image is divided into a plurality of zones and an illumination value of each zone is computed.

In operation S840, the illumination of each zone is computed based on the computed illumination value of each zone. In operation S820, the illumination conversion is performed with respect to the entire 3D image by the same amount of change. Therefore, a feature of each zone of the 3D image is not reflected. In operation S840, the illumination of each zone is converted based on the illumination value of each zone of the 3D image. Therefore, the feature of each zone of the 3D image is reflected and thus the user may clearly view the 3D image under the bright light.

According to an aspect, operation S840 may include maintaining a lookup table that includes a combination of an illumination value of each of zones constituting the 3D image and at least one converted illumination value corresponding to the illumination value.

Also, in operation S840, the converted illumination value of each zone is selected from the at least one converted illumination value based on the external illumination information by referring to the lookup table. Also, the illumination value of each zone is converted to the selected converted illumination value.

The methods described above including the 3D image converting method may be recorded, stored, or fixed in one or more computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing a three dimensional (3D) image, the apparatus comprising:
an image receiver to receive the 3D image and external illumination information associated with the 3D image;
a saturation converter to convert a saturation of the 3D image based on the external illumination information; and
an illumination converter to convert an illumination of the 3D image based on the external illumination information.

2. The apparatus of claim 1, wherein the image receiver receives the 3D image in a red-green-blue (RGB) form, and comprises:
a pre-processing unit to convert the received 3D image from the RGB form to a YCbCr form.

3. The apparatus of claim 1, wherein the saturation converter comprises:
an entire saturation converter to compute a saturation change amount of the 3D image based on the illumination of the 3D image, and convert the entire saturation of the 3D image by the saturation change amount; and
a zone saturation converter to divide the 3D image into a plurality of zones and convert a saturation of each zone based on an illumination value of each zone.

4. The apparatus of claim 1, wherein the saturation converter comprises:
a memory to store a lookup table that includes a combination of a saturation of each of zones constituting the 3D image and at least one converted saturation value corresponding to the saturation, and
the saturation converter selects a converted saturation value of the zone from the at least one converted saturation value by referring to the lookup table, and converts the saturation of each zone according to the selected converted saturation value.

5. The apparatus of claim 1, wherein the illumination converter comprises:
an entire illumination converter to compute an illumination change amount of the 3D image based on the illumination of the 3D image and convert the entire illumination of the 3D image by the illumination change amount; and
a zone illumination converter to divide the 3D image into a plurality of zones and convert an illumination of each zone based on an illumination value of each zone.

6. The apparatus of claim 1, wherein the illumination converter comprises:
a memory to store a lookup table that includes a combination of an illumination value of each of zones constituting the 3D image and at least one converted illumination value corresponding to the illumination value, and
the zone illumination converter selects a converted illumination value of the zone from the at least one converted illumination value based on the external illumination information.

7. A method of processing a 3D image, the method comprising:
receiving the 3D image and external illumination information associated with the 3D image;
converting a saturation of the 3D image based on the external illumination information; and
converting an illumination of the 3D image based on the external illumination information.

8. The method of claim 7, wherein the receiving receives the 3D image in a RGB form, and comprises:
converting the received 3D image from the RGB form to a YCbCr form.

9. The method of claim 7, wherein the converting of the saturation comprises:
computing a saturation change amount of the 3D image based on the illumination of the 3D image;
converting the entire saturation of the 3D image by the saturation change amount;
dividing the 3D image into a plurality of zones;
computing an illumination value of each zone; and
converting a saturation of each zone based on the computed illumination value of each zone.

10. The method of claim 7, further comprising:
maintaining a lookup table that includes a combination of a saturation of each of zones constituting the 3D image and at least one converted saturation value corresponding to the saturation,
wherein the converting of the saturation selects a converted saturation value of the zone from the at least one converted saturation value by referring to the lookup table, and converts the saturation of each zone according to the selected converted saturation value.

11. The method of claim 7, wherein the converting of the illumination comprises:
computing an illumination change amount of the 3D image based on the illumination of the 3D image;
converting the entire illumination of the 3D image by the illumination change amount;
dividing the 3D image into a plurality of zones;
computing an illumination value of each zone; and
converting the illumination of each zone based on the computed illumination value of each zone.

12. The method of claim 7, further comprising:
maintaining a lookup table that includes a combination of an illumination value of each of zones constituting the 3D image and at least one converted illumination value corresponding to the illumination value, and
the controlling of the illumination selects a converted illumination value of the zone from the at least one converted illumination value based on the external illumination information.

13. At least one medium comprising computer readable instructions implementing a method of processing a 3D image, the method comprising:
receiving the 3D image and external illumination information associated with the 3D image;
converting a saturation of the 3D image based on the external illumination information; and
converting an illumination of the 3D image based on the external illumination information.
